(19) United States
(12) Patent Application Publication
(10) Pub. No.: US 2026/0018717 A1
(43) Pub. Date: Jan. 15, 2026

(54) ELECTRIC BATTERY

(71) Applicant: G.D S.p.A., Bologna (IT)

(72) Inventors: Giacomo Noferini, Bologna (IT); Massimo Fortini, Bologna (IT)

(21) Appl. No.: 18/840,799

(22) PCT Filed: Dec. 19, 2022
(86) PCT No.: PCT/IB2022/062446

§ 371 Date: Aug. 22, 2024

(30) Foreign Application Priority Data
Feb. 25, 2022 (IT) 102022000003533

(51) Int. Cl. H01M 50/152; H01M 50/107; H01M 50/167; H01M 50/169; H01M 50/593

(52) U.S. Cl. CPC H01M 50/152; H01M 50/107; H01M 50/167; H01M 50/169; H01M 50/593

(57) ABSTRACT

An electric battery comprises a hollow container having a side wall and a bottom wall defining an inner cavity, an upper portion opposite to the bottom wall along an axial direction, an electrochemical cell inserted into the inner cavity of the hollow container, an insert made of electrically conductive material mechanically and electrically connected to an anode of the electrochemical cell, a lid placed to close the hollow container at the upper portion and comprising a peripheral portion. The insert made of electrically conductive material comprises a connection portion interposed between the upper portion of the hollow container and the peripheral portion of the lid and in electrical contact with at least the upper portion of the hollow container. The peripheral portion of the lid is in electrical contact with at least the upper portion of the hollow container.

### CROSS-REFERENCE TO RELATED APPLICATION DATA

This application is a U.S. National Stage Application of International Application No. PCT/IB2022/062446, filed Dec. 19, 2022, which claims the benefit of and priority to Italian Patent Application No. 102022000003533, filed Feb. 25, 2022 the disclosure of each is incorporated herein by reference in its entirety.

### TECHNICAL FIELD

The present invention refers to an electric battery usable in applications in which it is necessary to make electrical energy available.

### BACKGROUND

Electric batteries, also called secondary electrochemical cells or rechargeable batteries, are devices that convert chemical energy into electrical energy with a reversible oxidation-reduction reaction and that convert electrical energy into chemical energy by reversing this oxidation-reduction process.

The electric batteries comprise a hollow container inside which cavity an electrochemical cell formed by an anode, a cathode and a separator placed between anode and cathode is inserted. The cathode is electrically connected to a base bottom of the container and the anode is electrically connected to a top plate of the container.

In some types of applications, the electrochemical cell inserted into the hollow container is an electrochemical cell of the type called jelly roll or Swiss roll which comprises a sheet of insulating material on which an anode material, a separator material and a cathode material are laid, in succession and in the form of a lamina or sheet. The multilayer thus composed is wound on itself and inserted into the cavity of the container. The cathode material is put in electrical contact with an electrical pole placed on the bottom of the hollow container and electrically isolated from the container itself. The anode material is put in electrical contact with a lid which is placed at the end of the container and which creates a further electrical pole.

Examples of such applications are lithium-ion rechargeable batteries, nickel-cadmium rechargeable batteries and nickel-metal hydride rechargeable batteries.

In the Applicant's experience, the side wall of the hollow container must be in electrical contact with the anode material.

In accordance with the Applicant's experience, the electrical contact between the anode material and the side wall of the hollow container is implemented by welding an insert made of electrically conductive material, for example copper, to the anode material before inserting the electrochemical cell inside the hollow container. After the electrochemical cell has been inserted into the hollow container, the insert made of electrically conductive material is welded, inside the hollow cavity of the hollow container, to the inner surface of the side wall of the hollow container and the hollow container is closed with a lid. The lid, in contact with the container (which in turn is in contact with the insert made of conductive material), assumes the same electrical potential as the side wall of the hollow container.

The Applicant has noted that in the electric batteries briefly described above it may be difficult, or in any case costly in terms of large-scale production efficiency, to weld the insert made of electrically conductive material inside the cavity of the hollow container and to the inner surface of the side wall of the hollow container.

The Applicant has in fact verified that there may be a very limited space available for a weld between the insert made of electrically conductive material and the inner surface of the side wall of the hollow container, since this weld is carried out when the electrochemical cell is already inserted into the hollow container.

The Applicant has noted that in order to carry out adequate welds in said very limited space it may be necessary to resort to particular welding machines and particular welding techniques that could lead to relatively high execution times or that could lead to relatively high production costs.

The Applicant has also noted that any accidental detachment of the filler material of the weld could come into contact with the electrodes of the electrochemical cell, compromising their correct operation.

The Applicant has perceived that the electric batteries could be improved.

The Applicant has in fact perceived that after the positioning of the lid on the hollow container a mechanical union between a free rim of the hollow container and a free rim of the lid must necessarily follow in order to ensure a stable closure of the hollow container.

The Applicant has perceived that it could be possible to mechanically join to the free rim of the hollow container also the insert made of electrically conductive material and to mechanically join the latter to the lid.

The Applicant has therefore found that by shaping the insert made of electrically conductive material in such a way that a free rim of the insert made of electrically conductive material can be interposed between the free rim of the hollow container and the free rim of the lid, the subsequent processing of mechanical union of the free rims of the hollow container of the lid and of the insert made of electrically conductive material would ensure an electrical continuity between the insert made of conductive material, the lid and the side wall of the hollow container.

The present invention therefore concerns an electric battery.

### SUMMARY

Preferably, there is provided a hollow container having a side wall and a bottom wall defining an inner cavity.

Preferably, the hollow container has an upper portion opposite to said bottom wall along an axial direction.

Preferably, there is provided an electrochemical cell inserted into the inner cavity of said hollow container.

Preferably, there is provided an insert made of electrically conductive material mechanically and electrically connected to an anode of said electrochemical cell.

Preferably, there is provided a lid placed to close said hollow container at said upper portion and comprising a peripheral portion.

Preferably, said insert made of electrically conductive material comprises a connection portion interposed between the upper portion of the hollow container and the peripheral portion of the lid.

Preferably, said connection portion of the electrically conductive material is in electrical contact with at least the upper portion of the hollow container.

Preferably, said peripheral portion of the lid is in electrical contact with at least the upper portion of the hollow container.

The Applicant has verified that by interposing the connection portion of the electrically conductive material between the upper portion of the hollow container and the peripheral portion of the lid with the connection portion of the electrically conductive material in electrical contact with at least the upper portion of the hollow container and with the peripheral portion of the lid in electrical contact with at least the upper portion of the hollow container, the side wall of the hollow container and the lid are in electrical contact with the anode of the electrochemical cell.

The Applicant has also verified that this allows to avoid having to weld inside the cavity of the hollow container the insert made of electrically conductive material to the inner surface of the hollow container.

The Applicant believes that in this way it would not be necessary to have to resort to particular welding machines and particular welding techniques which are configured to operate in very limited spaces.

The Applicant also believes that, by avoiding having to weld inside the cavity of the hollow container the insert made of electrically conductive material to the inner surface of the hollow container, it can be prevented that any welds between the electrically conductive material and the hollow container can, in the event of accidental detachment, reach the electrochemical cell and compromise the correct operation of the electric battery.

The term “electrically conductive material” means in the present description and in the subsequent claims a material capable of having electrical current flow within it and having an electrical conductivity greater than 1×10⁴ siemens/metre at 20° C., preferably greater than 1×10⁵ siemens/metre at 20° C., more preferably greater than 1×10⁶ siemens/metre at 20° C.

The term “mechanically joining” or “mechanical union” in the present description and in the subsequent claims means joining together two or more parts or components so as to form an assembly in which the parts or components of the assembly are mechanically constrained together.

The term “direct physical contact” means in the present description and in the subsequent claims a physical contact between two parts or components with no means interposed between the two parts or components.

The term “direct electrical contact” in the present description and in the subsequent claims means an electrical continuity between two parts or components without electrical conductive means interposed between the two parts or components.

The term “electrical contact” in the present description and in the subsequent claims means an electrical continuity between two parts or components. An electrical contact between two parts or components may be direct or may have electrical conductive means interposed between the two parts or components.

The term “plastic deformation” or “plastically deformed” means in the present description and in the subsequent claims a deformation that does not disappear when the force that caused such deformation ceases.

The term “cold plastic deformation” means in the present description and in the subsequent claims a processing of metals that takes place at a processing temperature that is less than 40% of the melting temperature of the metal being processed, preferably less than 30% of the melting temperature of the metal being processed. For example, in a metal material having a melting temperature of 1000° C., a cold deformation occurs at a processing temperature of less than 400° C., preferably less than 300° C.

The electric battery has a main development axis with respect to the other two development axes perpendicular thereto and between them perpendicular. This axis is the main reference axis for the elements that are part of the electric battery of the present disclosure; with respect to it, all direction and similar indications will be referred thereto, such as “axial”, “radial” and “circumferential”; the indications “outwards” or “internally” and “inwards” or “externally” referred to radial directions that should be understood as in the direction of moving away from the axis or in the direction towards the axis.

The present invention may exhibit at least one of the preferred features described below. Such characteristics may be present individually or in combination with each other, unless expressly stated otherwise, in the electric battery of the present invention.

Preferably, no welds are provided between the insert made of electrically conductive material and an inner wall of the hollow container at axial positions comprised between the bottom wall of the hollow container and the peripheral portion of the lid.

Preferably, the connection portion of the insert made of electrically conductive material is in direct electrical contact with the upper portion of the hollow container.

Preferably, the connection portion of the insert made of electrically conductive material is in direct physical contact with the upper portion of the hollow container.

Preferably, at least the connection portion of the insert made of electrically conductive material and the upper portion of the hollow container are plastically deformed to define a stable mechanical union between the side wall of the hollow container, the lid and the insert made of electrically conductive material.

Preferably, the connection portion of the insert made of electrically conductive material and the upper portion of the hollow container are plastically deformed such that the shape of the connection portion of the insert made of electrically conductive material is substantially equal to the shape of the upper portion of the hollow container.

Preferably, the electrochemical cell comprises a multilayer wound on itself comprising a first layer made by an anode material making up said anode, a second layer made of cathode material making up a cathode and a third separator layer that separates the anode material from the cathode material.

Preferably, the first layer of the electrochemical cell is axially offset with respect to the second layer of the electrochemical cell such that the first layer comprises an axial end facing towards the lid and that is closer to the lid than an axial end of the second layer facing towards the lid.

Preferably, the axial end of the first layer of the electrochemical cell facing towards the lid is plastically deformed to create an anodic surface.

Preferably, said anodic surface is not continuous.

Preferably, said anodic surface is not flat.

Preferably, said insert made of electrically conductive material comprises a contact portion.

Preferably, said contact surface is placed in a central zone of the insert made of electrically conductive material.

Preferably, the connection portion of the insert made of electrically conductive material extends away from said contact portion in an axial direction towards said lid.

Preferably, the insert made of electrically conductive material is shaped as a cup with a bottom of the cup that creates said contact surface and with the side wall of the cup that creates the connection portion.

Preferably, said contact portion and said connection portion are made as one piece.

Preferably, the insert made of electrically conductive material is made of copper.

Preferably, the contact portion of the insert made of electrically conductive material is welded to the anode of said electrochemical cell.

Preferably, said contact portion of the insert made of electrically conductive material comprises a plurality of fins.

Preferably, said plurality of fins are defined by notches passing through the electrically conductive material.

The Applicant has found that this allows to make the contact portion of the insert made of electrically conductive material deformable, at the fins, in the axial direction.

Preferably, each through notch is continuous and develops along a curved trajectory.

Preferably, said curved trajectory comprises two side sections and a central section, wherein the central section is connected to radially outer ends of the side sections.

Preferably, said anode is welded to said insert made of electrically conductive material at at least one fin of said plurality of fins.

The Applicant has found that by welding the anode to at least one fin, any displacements in the axial direction (within the hollow container) of the insert of electrically conductive material can be compensated for by axial deformations of said at least one fin avoiding mechanically stressing the weld between the anode and the insert made of electrically conductive material.

The Applicant has also found that the deformability of the fins allows to compensate for any lack of uniformity of the anode surface and therefore to ensure that the connection portion of the insert made of electrically conductive material can slightly change its spatial orientation (for example during deformation plastically to define the stable mechanical union between the side wall of the hollow container, the lid and the insert made of electrically conductive material).

Preferably, said anode is welded to said insert made of electrically conductive material at all the fins of said plurality of fins.

Preferably, the hollow container is made of steel.

Preferably, the side wall and the bottom wall of the hollow container are made as one piece.

Preferably, the hollow container has a substantially cylindrical shape.

Preferably the lid is made of steel.

Preferably, the lid and the hollow container are made of the same material.

Preferably, the lid has a discoidal shape.

Preferably, the lid comprises a central portion from which the peripheral portion develops in a radially outer direction.

Preferably, the central portion and the peripheral portion of the lid are made as one piece.

In a first embodiment, the connection portion of the insert made of electrically conductive material is preferably in direct electrical contact with the peripheral portion of the lid.

In this embodiment, a weld is preferably provided acting between the lid and said upper portion of the hollow container.

Preferably, said weld is provided at an outer surface of the electric battery.

Preferably, said weld is not directly facing the inner cavity of the hollow container.

Preferably, said weld is not facing towards the anode of the electrochemical cell.

Preferably, at least said peripheral portion of the lid is placed between said weld and said electrochemical cell.

Preferably, said weld seals the lid and the upper portion of the hollow container together and isolates the inner cavity of the hollow container from the external environment.

Preferably, said weld also acts on the connection portion of the insert made of electrically conductive material.

Preferably, said weld is obtained by melting a free end of the connection portion of the insert made of electrically conductive material.

Preferably, said weld is provided between an outer surface of said lid, a free end of the upper portion of the hollow container and a free end of the connection portion of the insert made of electrically conductive material.

The Applicant has found that said weld may be advantageous to prevent the direct electrical contact between the connection portion of the insert made of electrically conductive material and the upper portion of the hollow container or the peripheral portion of the lid from being adversely affected by different thermal expansions between the insert made of electrically conductive material and the lid or between the insert made of electrically conductive material and the hollow container during the charging and discharging cycles of the electrochemical cell.

The Applicant has verified that the position of this weld does not require particular welding machines and welding techniques configured to operate in very limited spaces.

The Applicant also verified that even if welding residues were to be detached from the weld, such welding residues could not reach the cavity of the hollow container and the electrochemical cell.

In the first embodiment, preferably the peripheral portion of the lid is not plastically deformed in the definition of said stable mechanical union between the side wall of the hollow container, the lid and the insert made of electrically conductive material.

In this embodiment, said upper portion of the hollow container is preferably bent to form a curve.

Preferably, such a curve has a concavity facing radially inward.

Preferably, such a curve develops circumferentially along the entire upper portion of the hollow container forming a groove.

Preferably, said connection portion of the insert made of electrically conductive material is bent to form a curve.

Preferably, such a curve has a concavity facing radially inward.

Preferably, such a curve develops circumferentially along the entire connection portion of the insert made of electrically conductive material forming a groove.

Preferably, the curve defined by the connection portion of the insert made of electrically conductive material is inserted into the curve of the upper portion of the hollow container.

Preferably, said peripheral portion of the lid is inserted into the curve of the insert made of electrically conductive material.

In a second embodiment, preferably the peripheral portion of the lid is not in direct electrical contact with the connection portion of said insert made of electrically conductive material.

Preferably, said lid comprises an insulating layer of material having electrical insulating properties and protection against atmospheric agents.

Preferably, said insulating layer is placed on an inner surface of the lid facing the inner cavity of the hollow container.

In this embodiment, preferably the peripheral portion of the lid is superimposed on the connection portion of the insert made of electrically conductive material.

Preferably, the connection portion of the insert made of electrically conductive material is completely covered by the peripheral portion of the lid.

The Applicant has found that by providing the inner surface of the lid with the insulating layer and by covering the connection portion of the insert made of electrically conductive material with the peripheral portion of the lid, it is possible to isolate the inside of the hollow container and therefore the electrochemical cell from environmental agents.

In this embodiment, the connection portion of said insert made of electrically conductive material, the upper portion of the hollow container and the peripheral portion of the lid are crimped together to make an edging bent back on itself.

Preferably, at said edging, said upper portion of the hollow container is bent to form a curve.

Preferably, such a curve is placed outside the side wall of the hollow container.

Preferably, such a curve has a concavity facing axially towards the bottom wall of the hollow container.

Preferably, such a curve develops circumferentially along the entire upper portion of the hollow container forming a groove.

Preferably, at said edging, said connection portion of the insert made of electrically conductive material is bent to form a curve.

Preferably, such a curve has a concavity facing axially towards the bottom wall of the hollow container.

Preferably, such a curve develops circumferentially along the entire connection portion of the insert made of electrically conductive material forming a groove.

Preferably, the curve of said portion of the insert made of electrically conductive material is superimposed on the curve of the upper portion of the hollow container.

Preferably, at said edging, said peripheral portion of the lid is bent to form a curve.

Preferably, such a curve has a concavity facing axially towards the bottom wall of the hollow container.

Preferably, such a curve develops circumferentially along the entire peripheral portion of the lid forming a groove.

Preferably, the curve of said peripheral portion of the lid is superimposed on the curve of the insert made of electrically conductive material.

Preferably, the curve of said peripheral portion of the lid comprises a free end inserted into the curve of the upper portion of the hollow container.

Preferably, said free end is straight and forms a ring inserted into the curve of the upper portion of the hollow container.

Preferably, said peripheral portion of the lid is in direct electrical contact with the upper portion of the hollow container at said free end of the curve of said peripheral portion of the lid.

Further characteristics and advantages of the present invention will become clearer from the following detailed description of a preferred embodiment thereof, with reference to the appended drawings and provided by way of indicative and non-limiting example, in which:

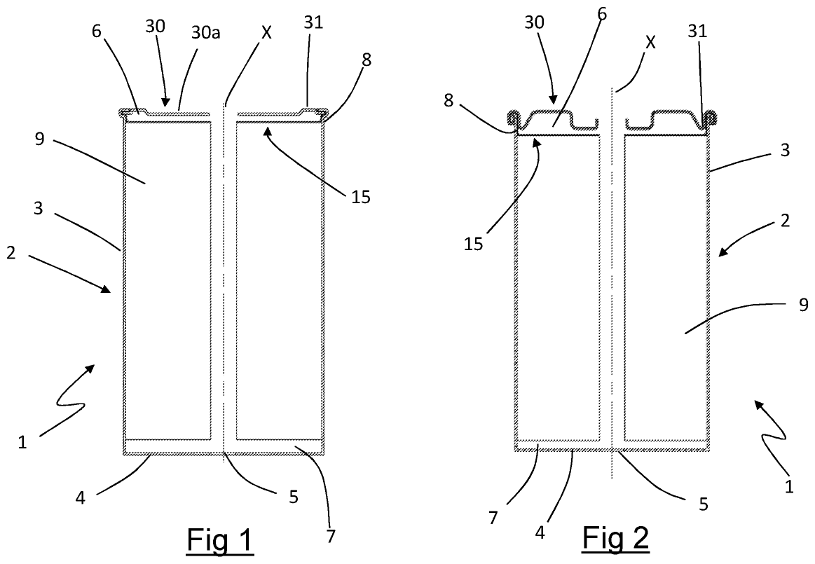

FIG. 1 is a schematic sectional view of an electric battery in accordance with the present invention and according to a first embodiment;

FIG. 2 is a schematic sectional view of an electric battery in accordance with the present invention and according to a second embodiment;

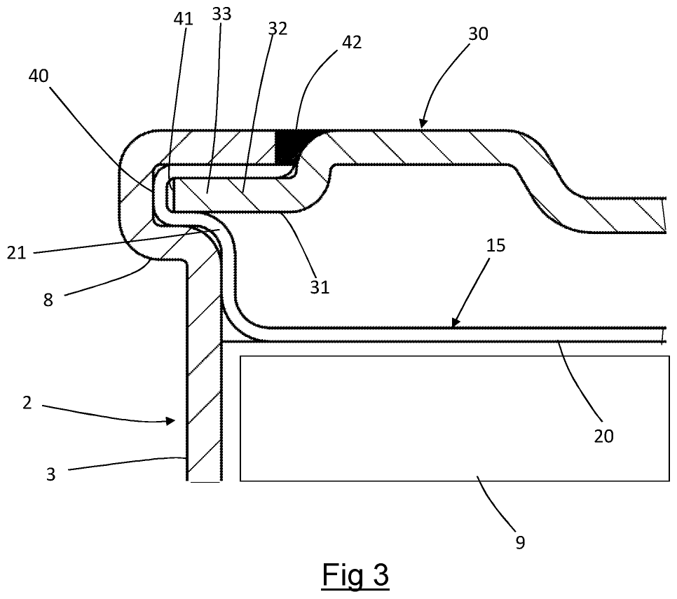

FIG. 3 is an enlarged view of a detail of the electric battery of FIG. 1;

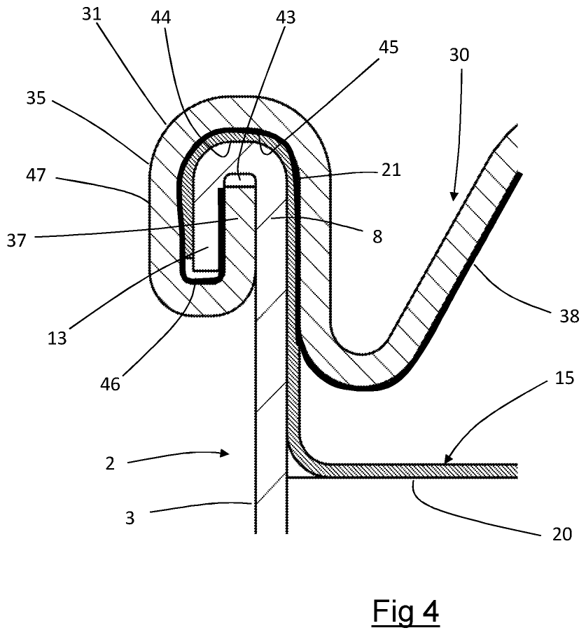

FIG. 4 is an enlarged view of a detail of the electric battery of FIG. 2;

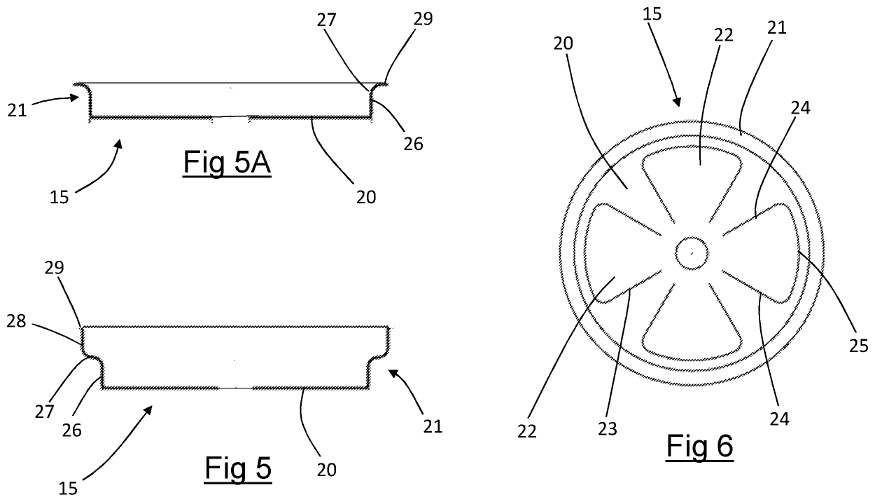

FIGS. 5, 5A and 6 are schematic views respectively from the side and from the top of a component of the electric battery of FIGS. 1 and 2;

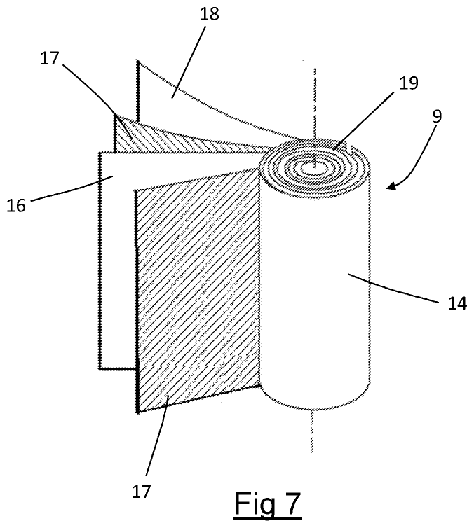

FIG. 7 is a perspective schematic view of a further component of the electric battery of FIGS. 1 and 2;

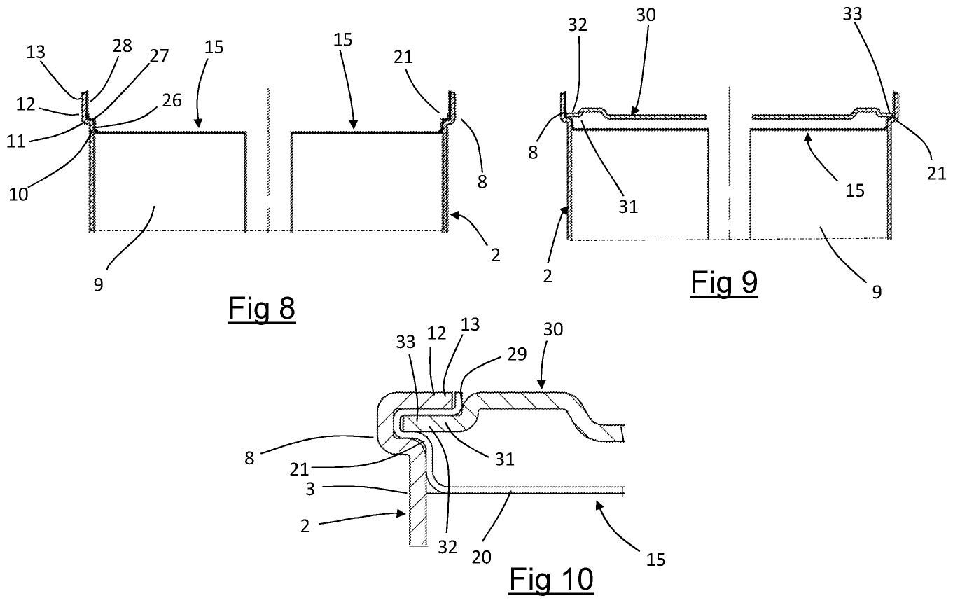

FIGS. 8 to 10 are schematic representations of battery assembly sequences of FIG. 1; and

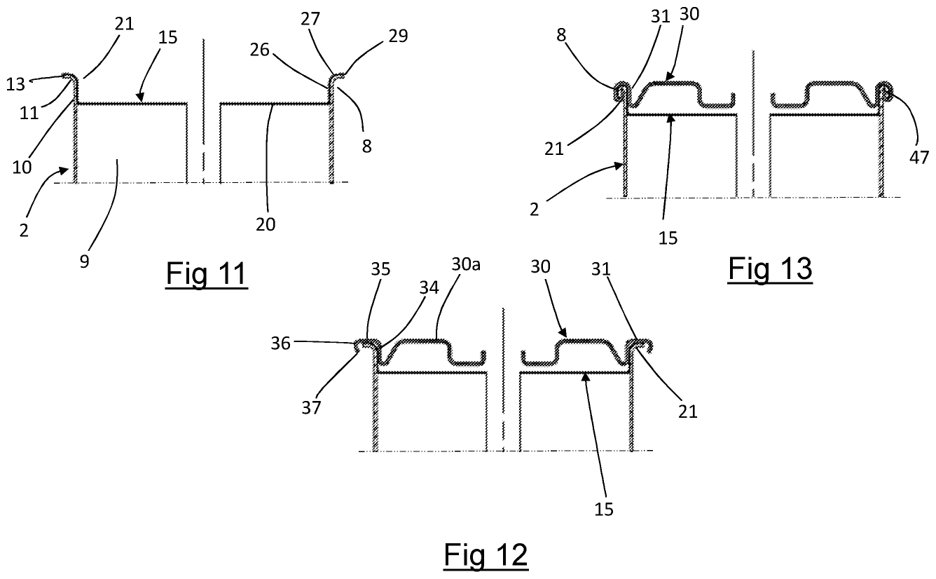

FIGS. 11 to 13 are schematic representations of battery assembly sequences of FIG. 2.

### DETAILED DESCRIPTION

The representations in the accompanying figures do not necessarily have to be understood in scale and do not necessarily respect the proportions between the various parts. In the figures, the same or similar elements of different embodiments will be indicated by the same reference numerals.

An electric battery in accordance with the present invention is indicated generically by the numerical reference 1.

A main development axis X is defined in the battery 1. An axial direction parallel to the main development axis X, a radial direction contained in a plane perpendicular to the main development axis X and passing through the main development axis X and a circumferential direction arranged around the main development axis X and contained in a plane perpendicular to the main development axis X are also defined.

For convenience of exposition, explicit reference will be made to an electric battery 1 of a generally cylindrical shape in which the main development axis X substantially coincides with an axis of symmetry of the electric battery 1.

However, the electric battery 1 may have different shapes from the cylindrical one, for example it may have a straight prism shape, for example with a rectangular base.

The electric battery 1 comprises a hollow container 2, a lid 30, an electrochemical cell 9 and an insert made of electrically conductive material 15.

The hollow container 2 comprises a side wall 3 and a bottom wall 4. The side wall 3 and the bottom wall 4 are made as one piece of steel. The bottom wall 4 and the side wall 3 define an inner cavity 7 of the hollow container 2. The bottom wall 4 and the side wall 3 preferably have the same thickness. The thickness of the side wall 3 and the bottom wall 4 is preferably between 0.1 millimetres and 1 millimetres, more preferably between from 0.2 millimetres and 0.5 millimetres, for example of 0.3 millimetres.

An electrical pole 5 is placed on the bottom wall 4 of the hollow container 2 and is electrically insulated from the bottom wall 4. The electrical pole 5 is placed in a central position on the bottom wall 4.

In an unassembled condition of the electric battery 1, the hollow container 2 has an opening 6 on the opposite side with respect to the bottom wall 4. The hollow container 2 comprises an upper portion 8 opposite to the bottom wall 4 along an axial direction. The upper portion 8 develops circumferentially around the opening 6.

In the first embodiment of the electric battery 1 illustrated in FIG. 1, the upper portion 8 comprises, in an unassembled condition of the electric battery 1, a straight section 10 (in an axial direction) that creates an annular extension of the side wall 3 of the hollow container 2 (FIG. 8). This straight section 10 is made as one piece with the side wall 3 of the hollow container 2. A curved section 11 that projects in a radially outward direction and that develops circumferentially forming a radially enlarged section for the upper portion 8 is connected to the straight section 10. From the curved section 11 a further straight section 12 develops (in an axial direction) which develops circumferentially to form a further annular section. The upper portion 8 ends with a free end 13. This free end 13 is also the free end of the further straight section 12.

In the second embodiment of the electric battery 1 illustrated in FIG. 2, the upper portion 8 comprises, in an unassembled condition of the electric battery 1, a straight section 10 (in an axial direction) that creates an annular extension of the side wall 3 of the hollow container 2 (FIG. 11). This straight section 10 is made as one piece with the side wall 3 of the hollow container 2. A curved section 11 that projects radially outward and that develop circumferentially forming a radially enlarged section for the upper portion 8 is connected to the straight section 10. The upper portion 8 ends with a free end 13. This free end 13 is also the free end of the curved section 11.

The electrochemical cell 9, better illustrated in FIG. 7, comprises an anode and a cathode.

The electrochemical cell 9 is of the jelly-roll or Swiss-roll type and comprises a multilayer 14 wound on itself. The multilayer 14 comprises a first layer 16 made of an anodic material, which makes the anode of the electrochemical cell 9, and a second layer 17 made up of a cathodic material, which makes the cathode of the electrochemical cell 9. The multilayer 10 further comprises a third separator layer (or more third layers) 18 separating the first layer 16 from the second layer 17. A person skilled in the art will be able to choose the material of the first layer 16, the second layer 17 and the third layer 18 to give the electrochemical cell 9 the desired electrical performance.

In preferred embodiments, the first layer 16 is axially offset from the second layer 17 so as to emerge axially from the multilayer 14 wound on itself with respect to the second layer 17. The portion of the first layer 16 that emerges axially from the multilayer 14 is plastically deformed in such a way that the free rim of the first layer 16 is bent to form an anode surface 19. This anode surface 19 is irregular and not continuous and has the function of increasing the contact surface of the first layer 16 at the axial end of the electrochemical cell 9.

The insert made of electrically conductive material 15 is preferably made of copper. As best illustrated in FIGS. 5, 5A and 6 (wherein the insert made of electrically conductive material 15 is illustrated not yet assembled in the electric battery 1), the insert made of electrically conductive material 15 has a shape along a section perpendicular to an axial direction which is substantially coincident with the shape of the bottom wall 4 of the hollow container 2. In the illustrated embodiment, the shape of the insert made of electrically conductive material 15 along a section perpendicular to an axial direction is substantially circular.

The insert made of electrically conductive material 15 comprises a substantially flat contact portion 20. The insert made of electrically conductive material 15 further comprises a connection portion 21. The connection portion 21 emerges axially from the radial end of the contact portion 20 and develops axially away from the contact portion 20.

A plurality of fins 22 are provided on the contact portion 20. Each fin 22 is defined by a respective through notch 23 that passes through the contact portion 20 in an axial direction. Each through notch 23 follows a curved trajectory comprising two side sections 24 and a central section 25 (FIG. 6). The side portions 24 develop along respective radial directions starting from a central zone of the contact portion 20 until reaching a peripheral zone of the contact portion 20. The central section 25 connects the two side sections 24 and has a substantially circumferential development. As schematically illustrated in FIG. 6, each fin 22 is substantially petal-shaped and can raise in an axial direction by rotating around a virtual hinge axis that joins the free ends of the two side sections 24 of the notches 23. The fins 22 are preferably between 2 and 8 in number, for example the fins 18 are 4.

FIG. 5 shows a side view of the insert made of electrically conductive material 15 (in an unassembled condition) of the first embodiment of the electric battery illustrated in FIG. 1. In this embodiment, the connection portion 17 comprises a straight section 26 (in an axial direction) that develops circumferentially to form an annular section. The straight section 26 is directly connected to the contact portion 20. A curved section 27 that projects radially outward and that develops circumferentially forming a radially enlarged section for the upper portion 17 is connected to the straight section 26. From the curved section 27 a further straight section 28 develops (in an axial direction) which develops circumferentially to form a further annular section. The connection portion 17 ends with a free end 29. This free end 29 is also the free end of the further straight section 28.

FIG. 5A shows a side view of the insert made of electrically conductive material 15 (in an unassembled condition) of the second embodiment of the electric battery illustrated in FIG. 2. In this embodiment, the connection portion 17 comprises a straight section 26 (in an axial direction) that develops circumferentially to form an annular section. The straight section 26 is directly connected to the contact portion 20. A curved section 27 that projects radially outward and that develops circumferentially forming a radially enlarged section for the upper portion 17 is connected to the straight section 26. The connection portion 17 ends with a free end 29. This free end 29 is also the free end of the curved section 27.

The lid 30 is made of steel. The lid 30 has a shape along a section perpendicular to an axial direction which is substantially coincident with the shape of the bottom wall 4 of the hollow container 2. In the illustrated embodiment, the shape of the lid 30 along a section perpendicular to an axial direction is substantially circular.

The lid may comprise one or more stiffening ribs. The lid 30 comprises a peripheral portion 31 radially surrounding a central portion 30a.

In the first embodiment of the electric battery 1 illustrated in FIG. 1, the peripheral portion 31 comprises, in an unassembled condition of the electric battery 1, a straight section 32 (FIG. 9) that develops in the radial direction. The peripheral portion 31 ends with a free end 33. This free end 33 is also the free end of the straight section 32.

In the second embodiment of the electric battery 1 illustrated in FIG. 2, the peripheral portion 31 comprises, in an unassembled condition of the electric battery 1, an axial straight section 34 (in an axial direction) that creates an annular shoulder (FIG. 12). A radial straight section 35 (in the radial direction) that projects radially outward and that develops circumferentially along the entire peripheral portion 31 is connected to the straight section 34. From the radial straight section 35 a further axial straight section 36 develops (in the axial direction) which develops circumferentially to form an annular section. The peripheral portion 31 ends with a free end 37. This free end 37 is also the free end of the further axial straight section 36.

In this embodiment, the lid 30 comprises an insulating layer 38 (schematically shown in FIG. 4) of material having electrical insulating properties and protection against atmospheric agents.

The insulating layer 38 is placed on an inner surface of the lid 30 intended to face the inner cavity 7 of the hollow container 2.

The insulating layer 38 may, for example, be a polyurethane lacquer resistant to moisture and salt vapours with a dielectric constant of less than 4.0.

In the assembled condition of the electric battery 1, the electrochemical cell 9 is inserted into the inner cavity 7 of the hollow container 2 with the cathode facing the bottom wall 4. The cathode is electrically connected with the electrical pole 5. In particular, the second layer 17 of the multilayer 14 is placed in electrical connection with the electrical pole 5 placed on the bottom wall 4 of the hollow container 2.

The anode is electrically connected with the insert made of electrically conductive material 15. This electrical connection is implemented by welding the contact portion 20 on the anode. In particular, the anode surface 19 is welded to the fins 22 of the contact portion 20 of the insert made of electrically conductive material 15.

In both embodiments, in the assembled condition of the electric battery 1 the connection portion 21 of the insert made of electrically conductive material 15 is interposed between the upper portion 8 of the hollow container 2 and the peripheral portion 31 of the lid 30, as schematically illustrated in FIGS. 3 and 4 which represent the assembled electric battery 1 in the two embodiments.

The connection portion 21 of the insert made of electrically conductive material 15 is in electrical contact with the upper portion 8 of the hollow container 2 and the peripheral portion 31 of the lid 30 is in direct electrical contact with the upper portion 8 of the hollow container 2.

The connection portion 21 of the insert made of electrically conductive material 15 is in direct physical contact with the upper portion 8 of the hollow container 2.

The connection portion 21 of the insert made of electrically conductive material 15 is further in direct physical contact with the peripheral portion 31 of the lid 30.

The connection portion 21 of the insert made of electrically conductive material 15 and the upper portion 8 of the hollow container 2 are plastically deformed so as to create a stable mechanical union between the side wall 3 of the hollow container 2, the lid 30 and the insert made of electrically conductive material 15.

In the first embodiment of the electric battery 1 illustrated in FIG. 1 and in the enlargement of FIG. 3, the connection portion 31 of the insert made of electrically conductive material 15 is also in direct electrical contact and in direct physical contact with the peripheral portion 31 of the lid 30.

In this embodiment, the upper portion 8 of the hollow container 2 is plastically deformed and forms a curve 40 defined between the curved section 11 and the further straight section 12.

The connection portion 21 of the insert made of electrically conductive material 15 is placed radially inside the upper portion 8 of the hollow container 2. The connection portion 21 of the insert made of electrically conductive material 15 is partially contained in the curve 40, as illustrated in FIG. 3.

In this regard, the connection portion 21 of the insert made of electrically conductive material 15 is plastically deformed and forms a curve 41 defined between the curved section 27 and the further straight section 28.

The curve 41 of the connection portion 21 of the insert made of electrically conductive material 15 is inserted into the curve 40 of the upper portion 8 of the hollow container 2 and receives therein the peripheral portion 31 of the lid 30. Said peripheral portion 31 of the lid 30 is not plastically bent or deformed.

As illustrated in FIG. 3, the free end 13 of the upper portion 8 of the hollow container 2 is substantially facing the lid 30 in the radial direction. A weld 42 is provided between the free end 13 of the upper portion 8 of the hollow container 2 and the lid 30. Such weld 42 also affects the free end 29 of the connection portion 21 of the insert made of electrically conductive material 15.

In the second embodiment of the electric battery 1 illustrated in FIG. 2 and in the enlargement of FIG. 4, the peripheral portion 31 of the lid 30 is not in direct electrical contact with the connection portion 21 of the insert made of electrically conductive material 15.

Also in this embodiment, the peripheral portion 31 of the lid 30 is in direct physical contact with the connection portion 21 of the insert made of electrically conductive material 15. In particular, the peripheral portion 31 of the lid 30 directly contacts the connection portion 21 of the insert made of electrically conductive material 15 through the insulating layer 38.

In this embodiment, the upper portion 8 of the hollow container 2 is plastically deformed and forms a curve 43 defined by the curved section 11.

The connection portion 21 of the insert made of electrically conductive material 15 overlaps the upper portion 8 of the hollow container 2. The connection portion 21 of the insert made of electrically conductive material 15 overlaps the outside of the curve 43, as illustrated in FIG. 4.

In this regard, the connection portion 21 of the insert made of electrically conductive material 15 is plastically deformed and forms a curve 44 defined by the curved section 27.

The curve 44 of the connection portion 21 of the insert made of electrically conductive material 15 contains the curve 43 of the upper portion 8 of the hollow container 2.

The peripheral portion 31 of the lid 30 at least partially overlaps the connection portion 21 of the insert made of electrically conductive material 15. The peripheral portion 31 of the lid 30 overlaps the outside of the curve 44 of the connection portion 21 of the insert made of electrically conductive material 15.

In this regard, the peripheral portion 31 of the lid 30 is plastically deformed and forms a curve 45 defined by the radial straight section 35. The curve 45 peripheral portion 31 of the lid 30 contains the curve 44 of the connection portion 21 of the insert made of electrically conductive material 15.

As illustrated in FIG. 3, the free end 37 of the peripheral portion 31 of the lid 30 is inserted into the curve 43 of the upper portion 8 of the hollow container 2. The free end 37 of the peripheral portion 31 of the lid 30 is in direct physical and direct electrical contact with the upper portion 8 of the hollow container 2.

In this regard, the peripheral portion 31 of the lid 30 is plastically deformed and forms a further curve 46 at the further axial straight section 36. This additional curve 46 contains the free end 13 of the upper portion 8 of the hollow container 2.

To assemble the electric battery 1, in both embodiments it is provided to prepare the hollow container 2, the lid 30, the insert made of electrically conductive material 15 and the electrochemical cell 9 as elements separated from one another.

Subsequently, it is envisaged mechanically and electrically connecting the insert made of electrically conductive material 15 to the anode of the electrochemical cell 9.

This operation is implemented by welding the anode to the contact portion 14 of the insert made of electrically conductive material 15. In particular, it is envisaged welding the anode surface 19 to all the fins 22 of the contact portion 20 of the insert made of electrically conductive material 15.

The assembly consisting of electrochemical cell 9 and insert made of electrically conductive material 15 is subsequently inserted into the inner cavity 7 of the hollow container 2 with the anode facing the upper portion 8 of the hollow container 2.

The connection portion 21 of the insert made of electrically conductive material 15 is then placed in direct electrical contact and in direct physical contact on the upper portion 8 of the hollow container 2.

This operation is implemented by at least partially overlapping the connection portion 21 of the insert made of electrically conductive material 15 to the upper portion 8 of the hollow container 2.

In accordance with the first embodiment, as illustrated in FIG. 8, the connection portion 21 of the insert made of electrically conductive material 15 is placed on the upper portion 8 of the hollow container 2 with the curved section 27 of the connection portion 21 overlapping the curved section 11 of the upper portion 8 of the hollow container 2. The further straight section 28 of the connection portion 21 is placed against the further straight section 12 of the upper portion 8 of the hollow container 2. The straight section 28 of the connection portion 21 is placed on the straight section 10 of the upper portion 8 of the hollow container 2.

The connection portion 21 of the insert made of electrically conductive material 15 is completely contained radially within the upper portion 8 of the hollow container 2.

In accordance with the second embodiment, as illustrated in FIG. 11, the connection portion 21 of the insert made of electrically conductive material 15 is placed on the upper portion 8 of the hollow container 2 with the curved section 27 of the connection portion 21 overlapping the curved section 11 of the upper portion 8 of the hollow container 2. The straight section 28 of the connection portion 21 is placed on the straight section 10 of the upper portion 8 of the hollow container 2.

The connection portion 21 of the insert made of electrically conductive material 15 is arranged radially inside the upper portion 8 of the hollow container 2.

Subsequently, in both embodiments it is envisaged placing the peripheral portion 31 of the lid 30 in direct physical contact with the connection portion 21 of the insert made of electrically conductive material 15.

This operation envisages at least partially overlapping the peripheral portion 31 of the lid 30 with the connection portion 21 of the insert made of electrically conductive material 15.

In accordance with the first embodiment, as illustrated in FIG. 9, the peripheral portion 31 of the lid 30 is placed on the connection portion 21 of the insert made of electrically conductive material 15 with the straight section 32 of the peripheral portion overlapping the curved section 27 of the connection portion 21.

In accordance with the second embodiment, as illustrated in FIG. 12, the peripheral portion 31 of the lid 30 is placed on the connection portion 21 of the insert made of electrically conductive material 15 with the radial straight section 35 of the peripheral portion 31 superimposed on the curved section 27 of the connection portion 21. The further axial straight section 36 of the peripheral portion 31 is located radially outside the connection portion 21 of the insert made of electrically conductive material 15. The axial straight section 34 of the peripheral portion 31 is placed on the straight section 26 of the connection portion 21 of the insert made of electrically conductive material 15.

Subsequently, in both embodiments it is envisaged mechanically joining the connection portion 21 of the insert made of electrically conductive material 15, the upper portion 8 of the hollow container 2 and the peripheral portion 31 of the lid 30 and putting the peripheral portion 31 of the lid 30 in electrical contact with the upper portion 8 of the hollow container 2.

This operation is implemented by plastically cold deforming at least the connection portion 21 of the insert made of electrically conductive material 15 and the upper portion 8 of the hollow container 2.

In accordance with the first embodiment, as illustrated in FIG. 10 only the connection portion 21 of the insert made of electrically conductive material 15 and the upper portion 8 of the hollow container 2 are plastically deformed.

Such deformation envisages plastically deforming the connection portion 21 of the insert made of electrically conductive material 15 to form the curve 41. With the same plastic deformation operation, the upper portion 8 of the hollow container 2 is also plastically deformed to form the curve 40. Thus, the curve 41 of the connection portion 21 and the curve 40 of the upper portion 8 are formed simultaneously.

The plastic deformation of the connection portion 21 of the insert made of electrically conductive material 15 and of the upper portion 8 of the hollow container 2 permanently constrains the peripheral portion 31 of the lid 30 to the containment body 2 and puts the peripheral portion 31 of the lid 30 in direct and permanent electrical contact with the upper portion 8 of the hollow container 2 (as well as with the connection portion 21 of the insert made of electrically conductive material 15).

The plastic deformation of the connection portion 21 of the insert made of electrically conductive material 15 and of the upper portion 8 of the hollow container 2 is implemented by cold bending simultaneously the further straight section 12 of the upper portion 8 and the further straight section 28 of the connection portion 21 on the peripheral portion 31 of the lid 30. The plastic deformation of the connection portion 21 of the insert made of electrically conductive material 15 and of the upper portion 8 of the hollow container 2 places the free end 29 of the connection portion 21 radially between the lid 30 and the free end 13 of the upper portion 8.

Despite the mechanical union between the connection portion 21 of the insert made of electrically conductive material 15, the upper portion 8 of the hollow container 2 and the peripheral portion 31 of the lid 30 puts the peripheral portion 31 of the lid 30 in electrical contact with the upper portion 8 of the hollow container 2 (and therefore allows a correct operation of the electric battery 1), it is envisaged welding the connection portion 21 of the insert made of electrically conductive material 15 on the lid 30 and on the upper portion 8 of the hollow container 2.

This operation envisages welding the free end 29 of the connection portion 15 of the insert made of electrically conductive material 15 on an outer surface of the lid 30 and on the free end 13 of the upper portion 8 of the hollow container 2. The weld is made by melting the free end 29 of the connection portion 15 of the insert made of electrically conductive material 15. This weld also fluid-tightly seals the inner cavity 7 of the hollow container 2.

The electric battery 1 in accordance with the first embodiment is thus completely assembled.

In accordance with the second embodiment, as illustrated in FIG. 13 (and as visible in FIG. 4) both the connection portion 21 of the insert made of electrically conductive material 15 and the upper portion 8 of the hollow container 2 and the peripheral portion 31 of the lid 30 are plastically deformed.

Such deformation envisages plastically deforming the connection portion 21 of the insert made of electrically conductive material 15 to form the curve 44. With the same plastic deformation operation, the upper portion 8 of the hollow container 2 is also plastically deformed to form the curve 43. With the same plastic deformation operation, the peripheral portion 31 of the lid 30 is also plastically deformed to form the curve 45. Thus, the curve 44 of the connection portion 21, the curve 43 of the upper portion 8 and the curve 45 of the peripheral portion 31 are formed simultaneously.

Still with the same plastic deformation operation, the further curve 46 of the peripheral portion 31 of the lid 30 is formed. Thus, the further curve 46 of the peripheral portion 31 is also formed simultaneously with the curve 45 of the peripheral portion 31.

The plastic deformation of the connection portion 21 of the insert made of electrically conductive material 15, of the upper portion 8 of the hollow container 2 and of the peripheral portion 31 of the lid 30 permanently constrains the peripheral portion 31 of the lid 30 to the containment body 2 and puts the peripheral portion 31 of the lid 30 in direct and permanent electrical contact with the upper portion 8 of the hollow container 2 (as well as putting the connection portion 21 of the insert made of electrically conductive material 15 in direct and permanent electrical contact with the upper portion 8 of the hollow container 2).

The plastic deformation of the connection portion 21 of the insert made of electrically conductive material 15, of the upper portion 8 of the hollow container 2 and of the peripheral portion 31 of the lid 30 is implemented by crimping which creates an edging 47 bent back on itself.

Crimping is a cold plastic deformation process that is used to join the edges of low thickness metal sheets. The resulting union is fluid-tight for the container, which is closed by such processing. The crimping used is a so-called “double seam” crimping formed by the mechanical interlocking of at least six layers of material between them. In the case of the second embodiment, these layers are seven and given by: two layers created by the connection portion 21 of the insert made of electrically conductive material 15, two layers created by the upper portion 8 of the hollow container 2 and three layers created by the peripheral portion 31 of the lid 30, as illustrated in FIG. 4.

A smaller or larger size of the portion 21 may result in six layers or, respectively, eight (the latter case if the portion 21 is further bent together with the lid 30).

The plastic deformation of the connection portion 21 of the insert made of electrically conductive material 15, of the upper portion 8 of the hollow container 2 and of the peripheral portion 31 of the lid 30 is implemented by cold bending the free end 37 of the peripheral portion 31 of the lid 30 on the free end 13 of the upper portion 8 of the hollow container 2 and by cold bending the assembly created by the free end 37 of the peripheral portion 31, free end 13 of the upper portion 8, radial straight section 35 of the peripheral portion 31, free end 29 of the connection portion 21 so as to bring them into contact against the side wall 3 of the hollow container 2.

The electric battery 1 in accordance with the second embodiment is thus completely assembled.

1. An electric battery-comprising:
a hollow container having a side wall and a bottom wall defining an inner cavity, an upper portion opposite to said bottom wall along an axial direction;
an electrochemical cell inserted into the inner cavity of said hollow container;
an insert made of electrically conductive material mechanically and electrically connected to an anode of said electrochemical cell;
a lid placed to close said hollow container at said upper portion and comprising a peripheral portion;
wherein said insert made of electrically conductive material comprises a connection portion interposed between the upper portion of the hollow container and the peripheral portion of the lid and in electrical contact with at least the upper portion of the hollow container, and wherein said peripheral portion of the lid is in electrical contact with at least the upper portion of the hollow container.

2. The electric battery in accordance with claim 1, wherein the connection portion of the insert made of electrically conductive material is in direct electrical contact with the upper portion of the hollow container.

3. The electric battery according to claim 2, wherein at least the connection portion of the insert made of electrically conductive material and the upper portion of the hollow container are plastically deformed to define a stable mechanical union between the side wall of the hollow container, the lid and the insert made of electrically conductive material.

4. The electric battery according to claim 1, wherein said insert made of electrically conductive material comprises a contact portion welded to the anode of said electrochemical cell, said connection portion extending away from said contact portion in an axial direction towards said lid.

5. The electric battery according to claim 4, wherein said contact portion of the insert made of electrically conductive material comprises a plurality of fins defined by notches passing through the insert made of electrically conductive material.

6. The electric battery according to claim 5, wherein said anode is welded to said insert made of electrically conductive material at at least one fin of said plurality of fins.

7. The electric battery according to claim 1, comprising a weld acting between the lid and said upper portion of the hollow container, said weld being provided at an outer surface of the electric battery.

8. The electric battery according to claim 7, wherein said weld is additionally acting on the connection portion of the insert made of electrically conductive material.

9. The electric battery according to claim 8, wherein said weld is provided between an outer surface of said lid, a free end of the upper portion of the hollow container and a free end of the connection portion of the insert made of electrically conductive material.

10. The electric battery according to claim 7, wherein said weld seals the lid and the upper portion of the hollow container together and insulates the inner cavity of the hollow container from an external environment.

11. The electric battery according to claim 1, wherein said peripheral portion of the lid is not plastically deformed in the definition of said stable mechanical union between the side wall of the hollow container, the lid and the insert made of electrically conductive material.

12. The electric battery according to claim 1, wherein said upper portion of the hollow container is bent to form a curve; said connection portion of the insert made of electrically conductive material is bent to form a curve inserted in the curve of the upper portion of the hollow container; said peripheral portion of the lid is inserted in the curve of the insert made of electrically conductive material.

13. The electric battery according to claim 1, wherein the connection portion of said insert made of electrically conductive material, the upper portion of the hollow container and the peripheral portion of the lid are crimped together to make an edging bent back on itself.

14. The electric battery according to claim 13, wherein at said edging said upper portion of the hollow container is bent to form a curve; said connection portion of the insert made of electrically conductive material is bent to form a curve superimposed on the curve of the upper portion of the hollow container; said peripheral portion of the lid is bent to form a curve superimposed on the curve of the insert made of electrically conductive material and comprises a free end inserted in the curve of the upper portion of the hollow container.

15. The electric battery according to claim 13, wherein said lid comprises an insulating layer of material having electrical insulating properties and protection against atmospheric agents; said insulating layer being placed on an inner surface of the lid facing the inner cavity of the hollow container.
